(19) United States
(12) Patent Application Publication
(10) Pub. No.: US 2025/0094921 A1
(43) Pub. Date: Mar. 20, 2025

(54) INFORMATION PROCESSING DEVICE, INFORMATION PROCESSING METHOD, COMPUTER PROGRAM PRODUCT, AND INFORMATION PROCESSING SYSTEM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Hideyuki AISU, Kawasaki (JP); Shizu SAKAKIBARA, Kawasaki (JP); Takufumi YOSHIDA, Funabashi (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki- shi (JP)

(21) Appl. No.: 18/585,470

(22) Filed: Feb. 23, 2024

(30) Foreign Application Priority Data
Sep. 19, 2023 (JP) 2023-150657

(51) Int. Cl. G06Q 10/087

(52) U.S. Cl. CPC G06Q 10/087

(57) ABSTRACT

According to an embodiment, an information processing device includes processors configured to: determine, based on a plurality of pieces of rack data including first identification information of one or more kinds of products housed in each rack, a processing sequence of a plurality of pieces of first order data including second identification information of one or more kinds of products to be picked, and one or more racks from which the products identified by the second identification information are to be picked; and perform hierarchical clustering that repeats processing of merging similar or matching pieces of first order data into a cluster such that a cluster number of a plurality of clusters resulting from the hierarchical clustering becomes equal to or more than a station number of a plurality of work stations where housing containers corresponding to at least some pieces of first order data are placed.

### CROSS-REFERENCE TO RELATED APPLICATIONS

This application is based upon and claims the benefit of priority from Japanese Patent Application No. 2023-150657, filed on Sep. 19, 2023; the entire contents of which are incorporated herein by reference.

### FIELD

An embodiment described herein generally relates to an information processing device, an information processing method, a computer program product, and an information processing system.

### BACKGROUND

A logistics system using a rack transfer warehouse is known, in which racks (racks housing products) that can be moved by an automated guided vehicle (AGV) or a worker are moved to a work station (picking station) where picking work of the products is performed.

As for such rack transfer systems, it is assumed in many cases that each order is added sequentially in real time. In other words, it is not usually anticipated that a large number of orders that can be changed in the processing sequence thereof are given to the system at a same timing. The related technologies are described, for example, in: Japanese Patent Application Laid-open No. 2020-033154; and Nils Boysen, et al., “Parts-to-picker based order processing in a rack-moving mobile robots environment”, European Journal of Operational Research, Research 262 (2017), 550-562

### BRIEF DESCRIPTION OF THE DRAWINGS

FIG. 1 is a diagram illustrating an overview of a configuration of an information processing system according to an embodiment;

FIG. 2 is a block diagram of an information processing device according to the present embodiment;

FIG. 3 is a diagram illustrating an example of an index to be generated;

FIG. 4 is a diagram illustrating an example of hierarchical clusters to be generated;

FIG. 5 is a diagram illustrating an example of orders rearranged according to a processing sequence;

FIG. 6 is a diagram illustrating an example where the orders illustrated in FIG. 3 are clustered;

FIG. 7 is a diagram illustrating an example where the orders illustrated in FIG. 3 are clustered;

FIG. 8 is a diagram illustrating an example of rearranged orders;

FIG. 9 is a diagram illustrating an example of rearranged orders;

FIG. 10 is a flowchart illustrating sequence determination processing according to the present embodiment;

FIG. 11 is a flowchart of clustering;

FIG. 12 is a diagram illustrating an example of a case with three work stations;

FIG. 13 is a diagram illustrating an example of a case with three work stations;

FIG. 14 is a flowchart illustrating order number determination processing;

FIG. 15 is a diagram illustrating an example where processing sequence of clusters is determined without using similarity;

FIG. 16 is a diagram illustrating an example where processing sequence of clusters is determined using similarity; and

FIG. 17 is a hardware configuration diagram of the information processing device according to the present embodiment.

### DETAILED DESCRIPTION

According to an embodiment, an information processing device includes one or more processors configured to: determine, based on a plurality of pieces of rack data including first identification information of one or more kinds of products housed in each of a plurality of racks, a processing sequence of a plurality of pieces of first order data including second identification information of one or more kinds of products to be picked from at least some of the plurality of racks, and one or more racks from which the products identified by the second identification information are to be picked, for each of the plurality of pieces of first order data; and perform hierarchical clustering that repeats processing of merging a plurality of similar or matching pieces of first order data into a cluster such that a cluster number that is a number of a plurality of clusters resulting from the hierarchical clustering becomes equal to or more than a station number that is a number of a plurality of work stations where housing containers corresponding to at least some of pieces of first order data among the plurality of pieces of first order data are placed.

With reference to the accompanying drawings, a preferable embodiment of an information processing device according to an embodiment will be described in detail hereinafter. The present embodiment can be applied to a logistics system using a rack transfer warehouse, for example.

As described above, in a conventional rack transfer system, orders are selected as picking targets sequentially as they are generated.

In the meantime, in a logistics system mainly targeted at Business to Business (B2B), for example, all orders to be processed within a certain period of time (for example, a unit of one day) may be given in advance. In such cases, the processing sequence of a plurality of orders can be changed as long as it is before the shipping deadline. For example, by appropriately rearranging the order processing sequence in advance and determining in advance racks assigned to each of the orders, it may be possible to improve the ratio of picking products assigned to a plurality of orders from a single rack (simultaneous picking ratio) and improve the efficiency of rack transfer work and picking work. Conventionally, however, there has been no concern regarding a function such as rearranging the order processing sequence of a large order in advance and determining the racks to be used in each of the orders so as to improve the work efficiency of the system as a whole.

Therefore, in the present embodiment, when a plurality of pieces of order data as information of unprocessed orders are given, the processing sequence of the orders and the racks to be used in each of the orders are determined so as to improve the simultaneous picking ratio by referring to a plurality of pieces of rack data regarding a plurality of racks each housing one or more kinds of products. Since there is a one-to-one correspondence between the order data and the order, determining the processing sequence of the orders corresponds to determining the processing sequence of the order data. Similarly, processing for the orders can be rephrased as processing for the order data.

Rack data is data that includes a rack ID that is information identifying a rack, and identification information (first identification information) for one or more kinds of products that are currently housed on each rack as inventory. The rack data includes identification information indicating the kind of each product that makes up a set of products (product set) housed on the rack, for example.

Order data is data that includes an order ID that is information identifying an order, and identification information (second identification information) of one or more kinds of products to be picked from at least part of a plurality of racks. The order data represents, for example, a unit of shipping instruction for each product to be packed in a same housing container for a same destination.

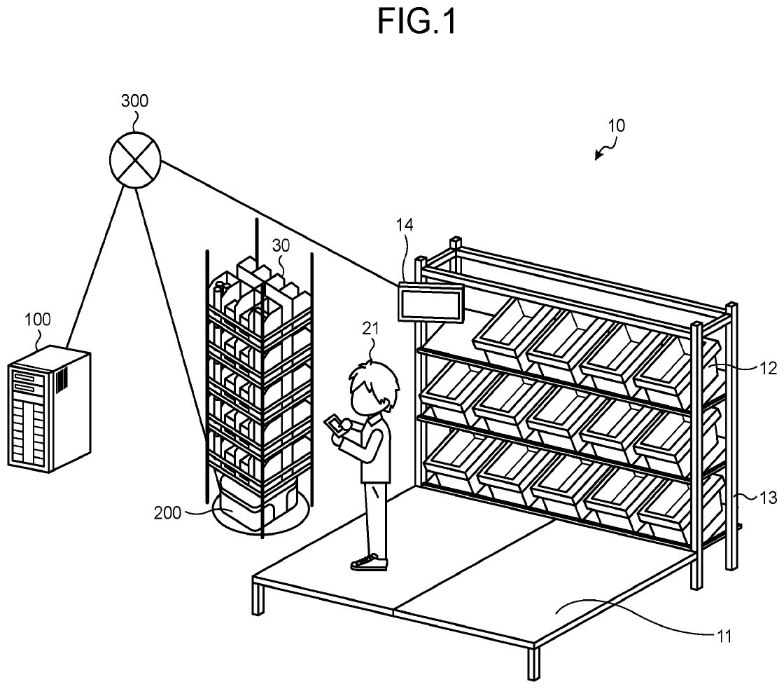

FIG. 1 is a diagram illustrating an overview of a configuration of an information processing system 10 (an example of the rack transfer system) according to the present embodiment. As illustrated in FIG. 1, the information processing system 10 includes an information processing device 100, a transfer device 200, movable racks 30, a work station 11, a plurality of housing containers 12, racks 13 for work, a display 14, and a network 300.

The work station 11 indicates the work place where picking is performed by a worker 21. While only one work station 11 is illustrated in FIG. 1, the information processing system 10 includes a plurality of work stations 11.

The rack 13 can accommodate a plurality of housing containers 12. The housing containers 12 correspond to each of a plurality of orders, for example. On the rack 13, the housing containers 12 each corresponding to at least some of a plurality of pieces of order data are placed. The display 14 is a display device for displaying information such as work instructions output from the information processing device 100, for example.

The transfer device 200 is a device for moving (transferring) the rack 30 to the work station 11, which is an AGV, for example. As described, the rack 30 is movable to the work station 11. While only one rack 30 is illustrated in FIG. 1, a plurality of the racks 30 are prepared in the information processing system 10, and the rack 30 selected according to the determined order processing sequence is moved to the work station 11. In a case of moving the rack by the worker 21, the transfer device 200 may not need to be provided. The rack 30 has a plurality of partitions, for example, and is capable of housing a plurality of kinds of products.

The network 300 is a network connecting the information processing device 100, the transfer device 200, and the display 14. The network 300 may be any form of network, including the Internet and a local area network (LAN). The network 300 may be a wireless network, a wired network, or a mixture of wireless and wired networks.

As illustrated in FIG. 1, the housing containers 12 for work corresponding to a plurality of orders are placed on the rack 13, and the worker 21 can perform picking for the orders in parallel. Note that picking may be performed by a picking robot or the like instead of the worker 21. Picking for each of the housing containers 12 is completed, when each of the products to be packed is placed thereinto. Completed orders (housing containers) are treated as completed and are sequentially removed from the work station 11, and the housing container 12 corresponding to the next order is put in.

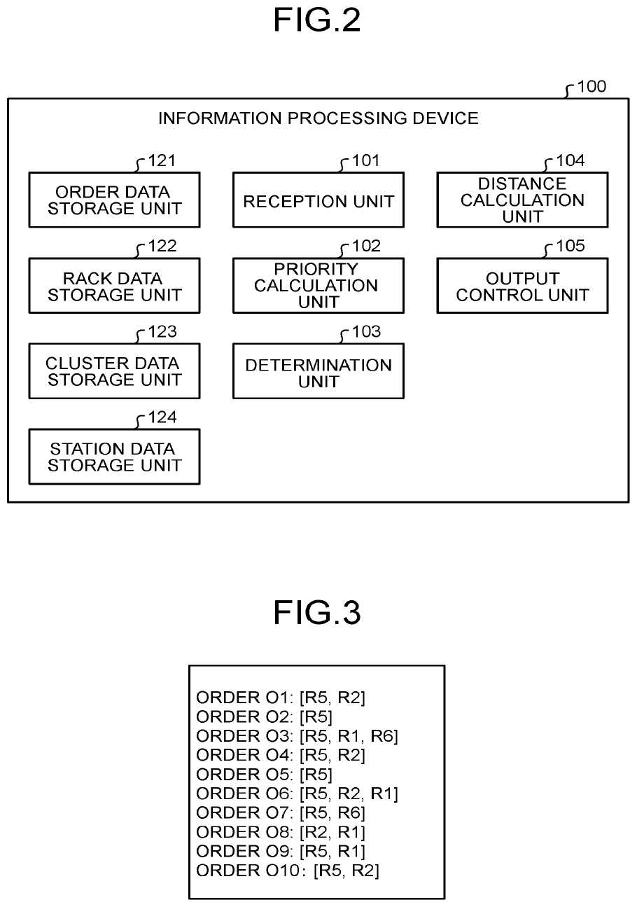

FIG. 2 is a block diagram illustrating an example of the configuration of the information processing device 100 according to the present embodiment. As illustrated in FIG. 1, the information processing device 100 includes a reception unit 101, a priority calculation unit 102, a determination unit 103, a distance calculation unit 104, an output control unit 105, an order data storage unit 121, a rack data storage unit 122, a cluster data storage unit 123; and a station data storage unit 124.

The reception unit 101 receives input of various kinds of data used in the information processing device 100. For example, the reception unit 101 receives a plurality of pieces of order data (first order data), a plurality of pieces of rack data, and work station data to be processed. The order data, the rack data, and the work station data may be generated by any method, and may be generated by external systems such as a system that receives orders and a system that manages inventory of products, for example. While the method for inputting each data may be any method, it is possible to use a method that receives the data from an external system via the network 300, for example.

The order data includes at least an order ID and identification information of the products included in the order. The order IDs may be indicated as order O1, order O2, order O3, and so on, for example. The identification information of products may be indicated as product A, product B, product C, and so on, for example. Note that Information included in the order data is not limited thereto. For example, the order data may include the number and quantity of each product.

The rack data includes at least a rack ID and identification information of the products to be housed on the rack. The rack ID may be indicated as rack R1, rack R2, rack R3, and so on, for example. Note that Information included in the rack data is not limited thereto. For example, the rack data may include the number of pieces of each product and housing position information of the product regarding which side of the rack and in which partition the product is housed.

The work station data includes at least a work station ID and the number of housing containers in each of the work stations. The number of housing containers corresponds to the number of orders that can be picked in parallel. The work station ID is information that identifies each of the work stations 11. The work station data may include information on orders that are already being assigned and scheduled to be processed at each of the work stations.

The reception unit 101 may receive data other than the order data, the rack data, and the work station data, such as product data including detailed information about each product (size, packing style, and the like), for example, as supplementary input data.

The priority calculation unit 102 calculates the priority for each of the racks. The priority is used by the determination unit 103 when determining the racks to be assigned to each of the orders. The priority is calculated such that the value becomes larger for the rack where picking work can be performed more efficiently, for example. For example, the priority calculation unit 102 may calculate the priority in the following method.
From the identification information of the products included in the rack data, create a list of products included in any of a plurality of pieces of order data, that is, a list (unassigned product list) of the products (unassigned products) that are not assigned despite of being requested in the orders.
Calculate the priority (product priority) for each of the products regarding the unassigned products. The priority for each of the products is, for example, the number of orders including the corresponding product, that is, the number of orders requesting the product (the number of assigned orders).
For each rack, the total value of the product priorities included in the unassigned product list is calculated as the priority of the rack (rack priority).

Based on the calculated priority of each rack, the determination unit 103 determines, for a plurality of pieces of order data, one or more racks from which the products are to be picked among the racks that house the products of identification information that matches the identification information of the products included in the order data.

For example, the determination unit 103 may assume that all orders can be processed in parallel (parallel picking is possible for the housing containers 12 corresponding to all orders), and iterate to sequentially select the rack of the highest simultaneous picking ratio, that is, the rack of the highest priority calculated by the priority calculation unit 102, to determine the racks to be used (assigned) for each order and the calling sequence of the racks regarding each of the orders.

The determination unit 103 also generates, for each order data, an index indicating the rack determined as the rack where the product is to be picked. The index is information that includes the rack ID of one or more racks where the product is to be picked, for example. Details of an index generation method will be described later.

The distance calculation unit 104 calculates the distances between a plurality of indexes generated for each of the pieces of order data. Details of a distance calculation method will be described later.

Furthermore, based on the rack data and the work station data, the determination unit 103 determines a plurality of pieces of order data to be distributed to each of the work stations 11 and the processing sequence of the pieces of distributed order data such that the ratio of picking products assigned to the pieces of order data from one rack (for example, the ratio of simultaneous picking from one rack:simultaneous picking ratio) is improved. Note that “simultaneous” does not mean that the times are strictly coincident timewise, but means that the products can be picked from the same single rack. The determination unit 103 determines the processing sequence of the pieces of order data such that turns become closer as the calculated distance is smaller. The determination unit 103 executes hierarchical (agglomerative) clustering that generates clusters represented by a hierarchical structure by repeating the processing of merging the orders corresponding to the indexes with small distances into a cluster, for example. The determination unit 103 then determines the processing sequence of the orders at each of the work stations 11 such that the orders in the same cluster are placed in close turns from each other.

As for the hierarchical clustering, the processing of finding a pair of two clusters with the smallest distance between the indexes applied to the clusters and merging them into one cluster is iterated while controlling the size of clusters to be generated such that clusters of equal to or more than the number of the work stations 11 are generated. This allows clustering of the pieces of order data such that the orders with the close distance between the corresponding indexes are included in the same cluster.

The determination unit 103 stores a binary tree with clusters (or orders) before being merged as child nodes (child clusters) and the cluster after being merged as a parent node (parent cluster) in the cluster data storage unit 123 as a clustering history. The determination unit 103 also stores clusters in a hierarchical structure representing the result of current clustering in the cluster data storage unit 123. When a clustering ending condition is satisfied, the clusters in a hierarchical structure representing the final processing result are stored in the cluster data storage unit 123. By recursively expanding the above binary tree such that child clusters belonging to the same parent cluster are adjacent to each other, the determination unit 103 determines the processing sequence of the orders such that the leaves (corresponding to the order data) of the binary tree belonging to the same parent cluster are arranged in close turns.

The output control unit 105 controls the output of various kinds of information processed by the information processing device 100. For example, the output control unit 105 outputs output information that includes information indicating sets of the order data allocated to each of the work stations 11 and the processing sequence of the orders (order sequence information), information indicating the racks to be used (assigned) for each order, and information indicating the calling sequence of the racks for each of the orders (rack sequence information).

At least part of each of the above units (the reception unit 101, the priority calculation unit 102, the determination unit 103, the distance calculation unit 104, and the output control unit 105) may be achieved by one or more processing units. Each of the above units is achieved by a single or a plurality of processors, for example. For example, each of the above units may be achieved by having a processor such as a central processing unit (CPU) execute a computer program, that is, by software. Each of the above units may be achieved by a processor such as a dedicated integrated circuit (IC), that is, by hardware. Each of the above units may be achieved by using a combination of software and hardware. When using a plurality of processors, each of the processors may achieve one of the units or may achieve two or more of the units.

The order data storage unit 121 stores the order data received by the reception unit 101. The rack data storage unit 122 stores the rack data received by the reception unit 101. The cluster data storage unit 123 stores data (indexes, binary trees as history, hierarchical clusters, and the like) generated by the hierarchical clustering performed by the determination unit 103. The station data storage unit 124 stores work station data.

Each of the storage units (the order data storage unit 121, the rack data storage unit 122, the cluster data storage unit 123, and the station data storage unit 124) may be configured with any commonly used storage media such as a flash memory, a memory card, a Random Access Memory (RAM), a Hard Disk Drive (HDD), and an optical disk.

Each of the storage units may be a physically different storage medium or may be achieved as a different memory area of a physically same storage medium. Furthermore, each of the storage units may be achieved by a plurality of physically different storage media.

Next, details of the index generation method will be described. The determination unit 103 generates, for each order data, an index indicating the rack determined as the rack where the product is to be picked. FIG. 3 is a diagram illustrating an example of the index to be generated. FIG. 3 illustrates examples of the index generated for the order of the corresponding ID next to each order ID. The index may include information indicating the calling sequence of the rack. For example, the index may be generated to arrange the rack IDs from left to right according to the calling sequence. It is also possible to generate the index in which the rack ID and the information indicating the calling sequence are associated.

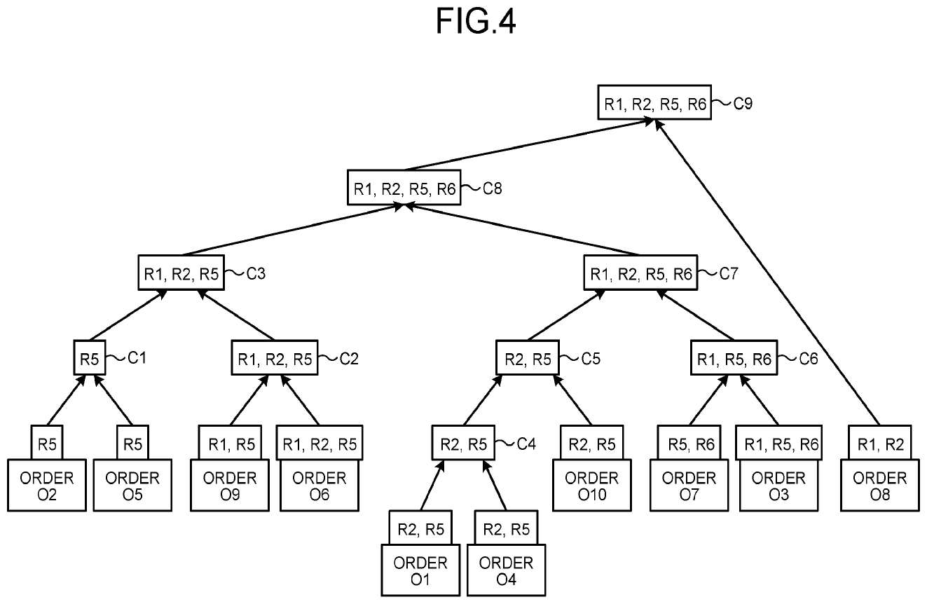

Next, an example of hierarchical clustering using indexes will be described. FIG. 4 is a diagram illustrating an example of hierarchical clusters to be generated by hierarchical clustering when there is a single work station to be the target.

First, the distance calculation unit 104 calculates the distance between a plurality of generated indexes. The distance calculation unit 104 calculates, as the distance, the total number of unmatching racks (rack IDs) between two indexes, for example. Not limited thereto, the distance may be calculated by the following methods, for example, and there is no limit set for the calculation method.
The distance is defined as the value acquired by multiplying the total number of matching racks by a negative coefficient.
The distance is the value of the sum of the total number of unmatching racks and the total number of matching racks, each multiplied by a coefficient.
When the index is weighted for each rack, the sum total of the weights (may be weights multiplied by a negative coefficient) may be used as the distance for each matching rack. For example, when the weight of the rack R5 included in the index of the order O1 in FIG. 3 is “2” and the weight of the rack R2 is “1”, the distance calculation unit 104 calculates the distance as “−2” when only the rack R5 matches, the distance as “−1” when only the rack R2 matches, and the distance as “−3” when the rack R5 and the rack R2 both match.

Next, the determination unit 103 generates clusters in a hierarchical structure by repeating the processing of merging the orders with the indexes of a small distance into one cluster, or clusters into one cluster, or an order and a cluster into one cluster. In FIG. 3, the indexes of the orders with the order IDs order O2 and order O5 match in respect that those indexes include only R5, for example. When using distances that have smaller values for the indexes including only the matching rack IDs, the determination unit 103 merges the orders with the order IDs order O2 and order O5 into a single cluster.

Cluster C1 in FIG. 4 indicates the cluster merged in this manner. Note that C1 to C9 represent information that identifies each cluster. The determination unit 103 stores a binary tree with the two indexes before being merged as child nodes and the cluster after being merged as a parent node in the cluster data storage unit 123. In the same manner, the determination unit 103 iterates the processing until the clustering ending condition is satisfied.

FIG. 4 illustrates an example of a single integrated cluster. As illustrated in FIG. 4, as the index for the merged cluster, the union of the rack IDs assigned to each order belonging to the cluster is used, for example.

Then, by recursively expanding the binary tree such that the child clusters belonging to the same parent cluster are adjacent to each other, the determination unit 103 determines the processing sequence of the orders such that the two orders corresponding to leaf nodes belonging to the same cluster are arranged in close turns.

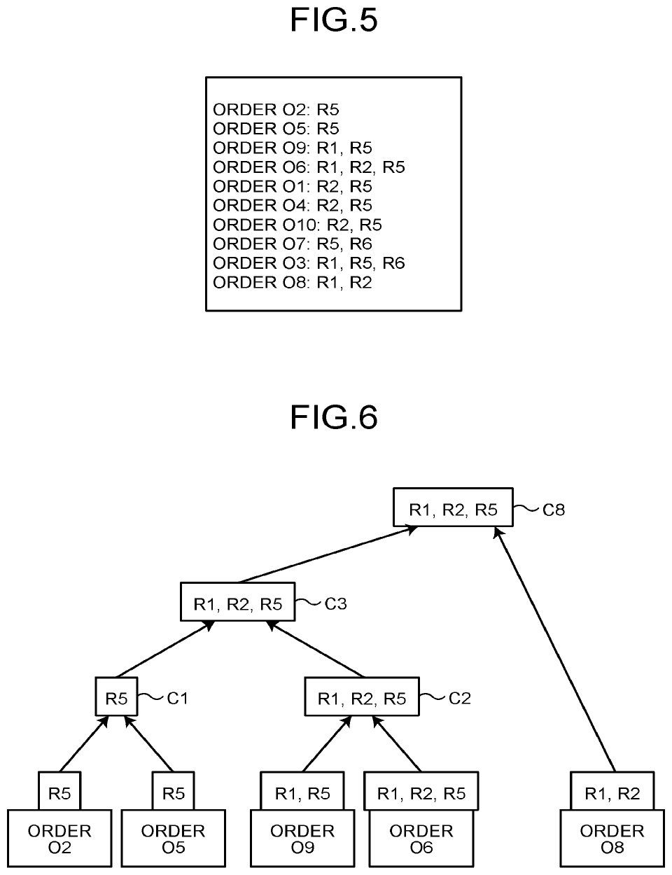

FIG. 5 is a diagram illustrating an example of orders rearranged according to the determined processing sequence. FIG. 5 is an example of orders rearranged based on the clusters illustrated in FIG. 4. As illustrated in FIG. 4, the clusters include ten leaf nodes corresponding to ten orders. The determination unit 103 determines the processing sequence of the orders by recursively following the parent-child relationship of the binary tree (expanding the binary tree) from the cluster C9 discovered at last, for example. In the example of FIG. 4, the determination unit 103 rearranges the orders according to the sequence of FIG. 5 by following the parent-child relationship in a manner as follows and arranging the leaves (orders) in the order they are reached.
C9→C8→C3→C1→order O2→C1→order O5→C1→C3→C2→order O9→C2→order O6→C2→C3→C8→C7→C5→C4→order O1→(omitted)→C8→C9→order O8

When there are a plurality of work stations 11, It is assumed that after all orders are integrated into one cluster as in the example in FIG. 4, the orders are rearranged according to the determined processing sequence, and then the order data is divided into data groups for each of the work stations 11. Such a method may lead to a situation in which a cluster is forcibly split into a different work station 11 to be processed in the middle thereof. Such a situation may result in reducing the simultaneous picking ratio.

Therefore, when there are a plurality of the work stations 11, the determination unit 103 according to the present embodiment executes hierarchical clustering such that the number of clusters (cluster numbers) becomes equal to or greater than the number of target work stations 11 (the number of stations). In other words, the determination unit 103 controls the size of each of the clusters and does not integrate them into a single cluster.

For example, during the processing of merging the orders into clusters, when the total number of orders in a cluster after merging exceeds the target size, the determination unit 103 performs determination processing to exclude a pair of the corresponding orders, a pair of the clusters, or a pair of an order and a cluster from merging candidates.

The target size is determined considering that allocating clusters in a size larger than the target size to a single work station 11 is likely to unbalance the workload and to force a split, for example.

Assuming that the number of the work stations 11 is N and the number of all orders is M, for example, the target size is determined by M/N to level the workload. In this case, whether the cluster size exceeds the target size is determined by a determination condition that is whether the number of orders included in the cluster exceeds the target size, for example.

The determination condition used in the determination processing is not limited thereto, and may also be the following determination conditions, for example. The determination processing may also be executed to make exclusion from the merging candidates when any of the determination conditions is met.
Whether the total number of products in the cluster after being merged exceeds the target size.
Whether the total number of product kinds in the cluster after being merged exceeds the target size.

Furthermore, when there are orders in process, the determination unit 103 may use the information of the work station data to determine the target size such that the sum of the workload of the orders in process and the workload of the orders to be newly allocated to each of the work stations 11 is leveled. An order in process is, for example, an order that is already allocated to each of the work stations 11 and cannot be changed, or an order that is being worked on. The method for determining the target size in this case will be described later.

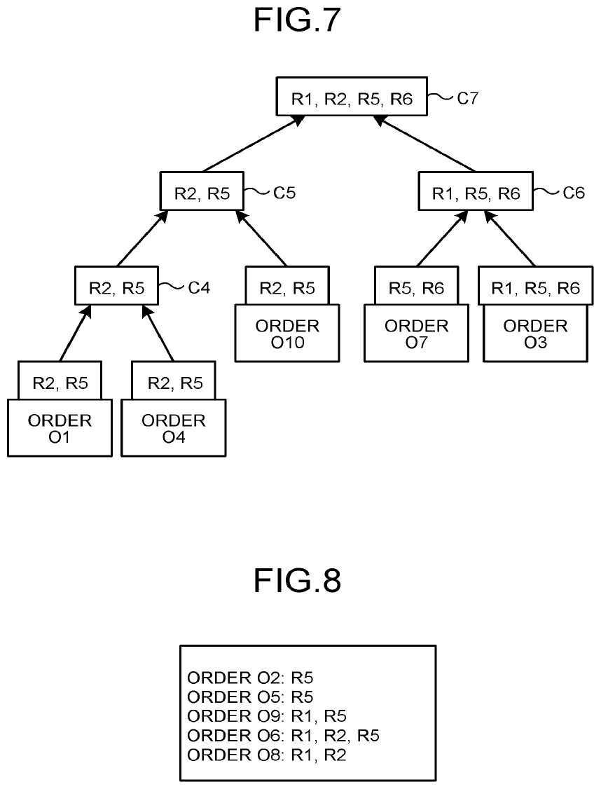

FIG. 6 and FIG. 7 are diagrams illustrating examples in which the orders in FIG. 3 are clustered targeted at two work stations 11. Since the number of orders in FIG. 3 is 10, the target size of the cluster is, for example, 10/2=5.

For example, the number of orders in cluster C7 is 5, which reaches the target size. Therefore, no more other clusters will be merged into the cluster C7. In other words, hierarchical clustering ends at the point where the cluster C8 illustrated in FIG. 6 and the cluster C7 illustrated in FIG. 7 are generated.

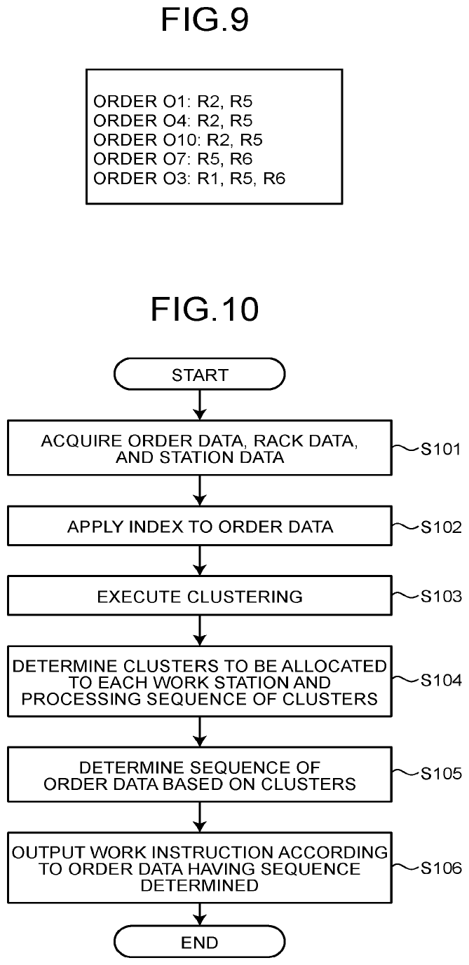

FIG. 8 and FIG. 9 are diagrams illustrating examples of orders rearranged by the method described above based on the clusters illustrated in FIG. 6 and FIG. 7, respectively.

It is assumed that ten orders that are rearranged based on clusters merged into one as in the example in FIG. 5 are divided into five orders from the first to fifth orders and the five orders from the sixth to tenth orders. In this case, orders O1 and O4 that use the same racks (R2 and R5) are divided and allocated to two work stations 11.

In contrast, in the example of the two clusters generated by the procedure of the present embodiment, the orders O1 and O4 are both merged into the cluster C7 (FIG. 7). Thus, as illustrated in FIG. 9, the orders O1 and O4 are allocated to the same work station 11. In other words, the simultaneous picking ratio can be improved.

Next, the sequence determination processing performed by the information processing device 100 according to the present embodiment will be described. FIG. 10 is a flowchart illustrating an example of the sequence determination processing according to the present embodiment.

The reception unit 101 receives input of a plurality of pieces of order data, a plurality of pieces of rack data, and work station data (step S101). The pieces of order data may be acquired by extracting unprocessed order data from the list of input orders.

Then, the determination unit 103 iterates selecting the highest priority rack and adding the rack ID of the selected rack to the index for all orders that can be assigned from the selected rack in the unprocessed order data, and applies indexes to all orders (step S102).

Next, the determination unit 103 executes hierarchical clustering (step S103). In hierarchical clustering, the determination unit 103 generates a binary tree with orders or clusters before being merged as child nodes and a cluster after being merged as a parent node, and stores the generated binary tree in the cluster data storage unit 123. Details of the hierarchical clustering will be described later.

After clustering is completed, the determination unit 103 determines which clusters are to be allocated to each of the work stations 11 and the sequence of processing the clusters at the work stations 11 (step S104).

Since the size of all generated clusters may not necessarily match the target size, the number of generated clusters may become greater than the number of work stations 11. In that case, the determination unit 103 may determine the clusters to be allocated so as to level the workload at each of the work stations 11. In other words, the determination unit 103 determines a plurality of pieces of order data to be allocated to each of the work stations 11 such that the total of the number of pieces of order data in process (in progress) (second order data) and the number of pieces of order data to be allocated among a plurality of pieces of unallocated order data is equalized, among the work stations 11.

While any method may be used as an allocation method for leveling, a method utilizing an algorithm for a combinatorial optimization problem called bin packing may be used, for example. For example, the determination unit 103 allocates a plurality of clusters, in order from the cluster with the largest size, to the work stations where the total size of one or more already-allocated clusters is smaller than the other work stations.

For example, it is assumed that there are two work stations 11A and 11B as the work stations 11, and the total number of orders is 15. It is also assumed that four clusters are generated, which are cluster C1 with two orders, cluster C2 with three orders, cluster C3 with four orders, and cluster C4 with six orders.

The determination unit 103, for example, rearranges the clusters in order from the largest size and sequentially allocates the clusters in the largest size to the work stations 11 with the smallest total size of the already allocated clusters. In the above example of the four clusters, the determination unit 103 determines, in the following order, to allocate the cluster C4 for the work station 11A, the cluster C3 for the work station 11B, the cluster C2 for the work station 11B, and the cluster C1 for the work station 11A.

While the processing sequence of a plurality of clusters in a case where the clusters are allocated to a single work station 11 may be determined in any manner, it is possible to use, for example, a determination method that defines the sequence of allocation determined for the corresponding work station 11 as the processing sequence.

Returning to the explanation of FIG. 10, the determination unit 103 determines the processing sequence of the orders such that the two orders corresponding to leaf nodes belonging to the same cluster are arranged in close turns by recursively expanding the binary tree such that the child clusters belonging to the same parent cluster are adjacent to each other (step S105), and generates an order list in which the order data is arranged in the determined processing sequence. When the clusters are allocated to a single work station 11, the determination unit 103 combines the order lists determined for a plurality of clusters according to the processing sequence of the clusters determined at step S104 so as not to disrupt the sequence of the orders in the original order lists.

The output control unit 105 outputs the order list including the order data for which the sequence is determined and a work instruction for the racks to be used for each order (step S106).

The output control unit 105 may use the fact that the simultaneous picking ratio is calculated for each rack in the process of the processing for determining the racks to calculate at least one selected from the number of times of picking work required on each rack and the overall work time predicted value, and output the calculated result along with the information of the racks where each of the products included in the order data is picked.

For example, the simultaneous picking ratio for a rack is the number of kinds of products that can be picked simultaneously for a plurality of orders from that rack. In that case, the number of times of picking work can be calculated as the same value as the simultaneous picking ratio. The time for picking work can be calculated, for example, by the product of the number of times of picking work and the unit time. The unit time represents an amount of time defined in advance for one-time picking work.

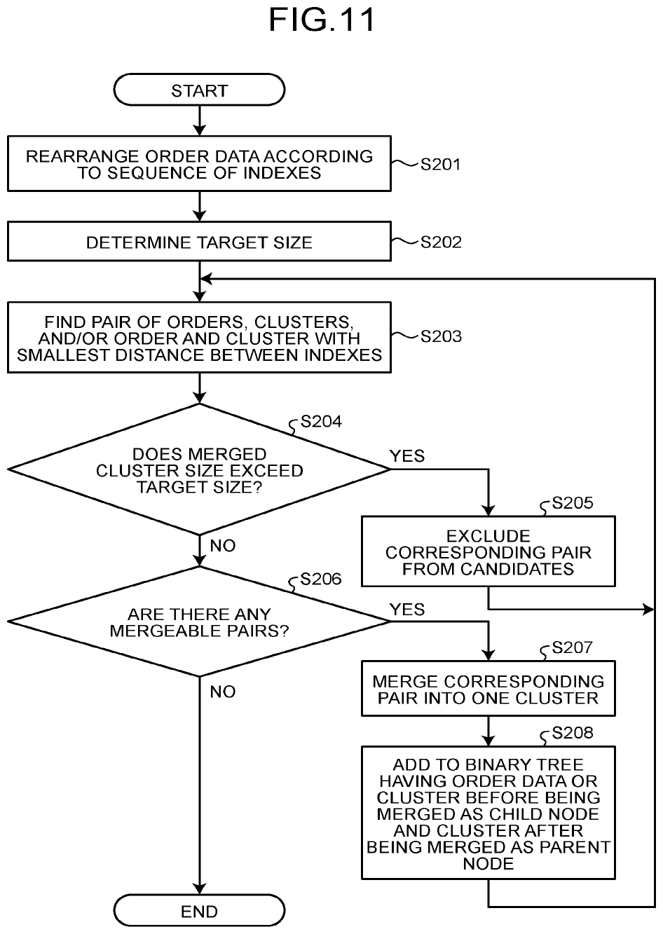

Next, details of the clustering performed at step S103 will be described. FIG. 11 is a flowchart illustrating an example of clustering.

The determination unit 103 rearranges the order data according to the sequence of indexes (step S201). The determination unit 103 determines the target size from the number of stations and the order data, for example (step S202). For example, the determination unit 103 determines, as the target size, the value acquired by dividing the total number of pieces of order data by the number of stations.

The determination unit 103 finds a pair of orders, a pair of clusters, or a pair of an order and a cluster, where the distance between the indexes thereof is the smallest and equal to or less than a threshold (step S203). Note that the distance between the indexes is calculated by the distance calculation unit 104.

The determination unit 103 determines whether the size of the merged cluster, when the found pair is merged, exceeds the target size (step S204). When exceeding the target size (Yes at step S204), the determination unit 103 excludes the pair from the merging candidates (step S205) and returns to step S203 to repeat the processing.

When not exceeding the target size (No at step S204), the determination unit 103 determines whether there is a pair that can be merged (step S206). When there is a pair that can be merged (Yes at step S206), the determination unit 103 merges the pair into one cluster (step S207). The determination unit 103 updates the binary tree with the order or cluster before being merged as the child node and the cluster after being merged as the parent node, stores the updated binary tree in the cluster data storage unit 123 (step S208), and then returns to step S203 to repeat the processing.

When there is no pair that can be merged (No at step S206), clustering is ended.

As described, in the present embodiment, by using a plurality of pieces of order data and a plurality of pieces of rack data acquired in advance, it is possible to determine the processing sequence of the pieces of order data, the racks to be used for each order, and the calling sequence to be able to execute picking work more efficiently.

In actual operations, there may be situations where a group of orders (batch) is input separately in several times, situations where the number of work stations 11 to be used during one-time batch processing is changed and re-planned, and the like. Therefore, even in such situations arise, it is necessary to maintain a high simultaneous picking ratio.

As described above, when there are orders in process, it is possible to use the information of the work station data to ensure that the sum of the workload of the orders in process and the workload of the additional orders to be allocated to each of the work stations 11 is leveled at each of the work stations 11.

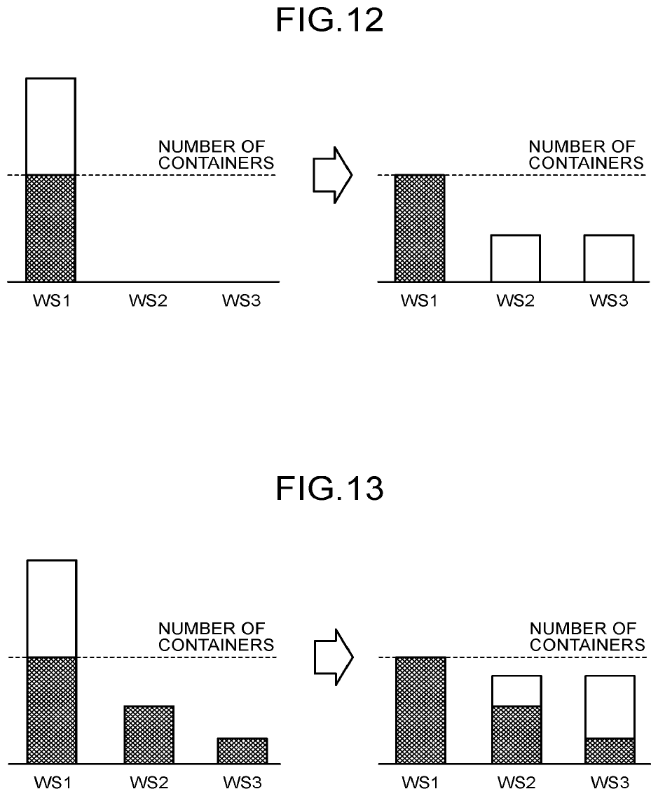

Hereinafter, processing for such a case will be described by referring to FIG. 12 to FIG. 14. FIG. 12 and FIG. 13 illustrate examples of a case with three work stations 11 (hereafter referred to as work stations WS1, WS2, and WS3). The number of containers indicates the number of housing containers 12. Once an order is expanded in the housing container 12, the allocation thereof cannot be changed in principle, since the products may have already been assigned partially.

In FIG. 12 and FIG. 13, the black bars indicate the number of orders that are already allocated to each of the work stations 11 and cannot be changed (orders for which picking work is uncompleted), and the white bars indicate the number of new orders to be additionally allocated to the work stations 11 and the processing sequence thereof is to be determined. The left side of the arrow indicates an example where it is assumed to allocate the orders to be added only to the work station WS1. The right side of the arrow indicates a case where the orders to be added are allocated such that the number of orders at a plurality of work stations 11 becomes as equal as possible.

The determination unit 103 determines the number of orders to be allocated to each of the work stations 11 such that the sum of the number of already allocated orders (black bars) and the number of orders to be additionally distributed (white bars) becomes as equal as possible among the work stations 11, as illustrated on the right side of the arrows in FIG. 12 and FIG. 13.

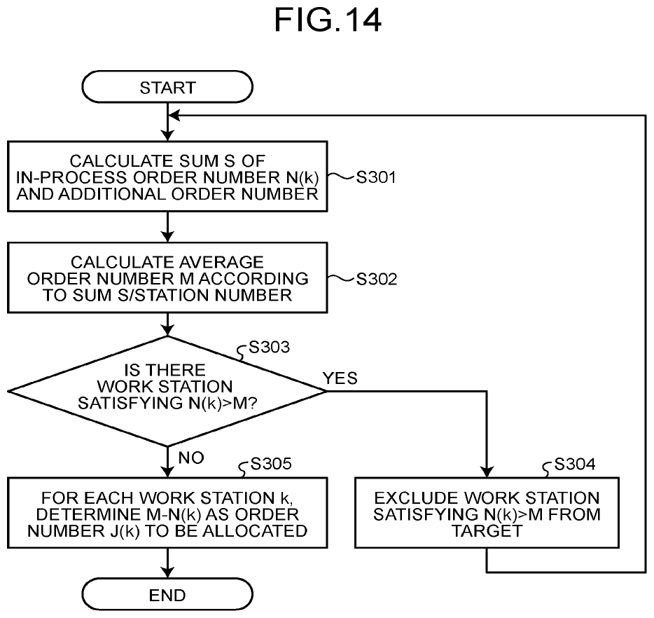

FIG. 14 is a flowchart illustrating an example of the order number determination processing in such a case. Hereinafter, among the work stations 11, the kth (k is an integer equal to or greater than 1 and equal to or less than the number of stations) work station 11 may be referred to as the work station k.

The determination unit 103 calculates the sum S of the number of in-process orders N(k) at the work station k and the number of additional orders (step S301). The determination unit 103 calculates the average order number M for each of the work stations 11 by dividing the sum S by the number of stations (step S302).

The determination unit 103 determines whether there is a work station k that satisfies N(k)>M (step S303). When there is a work station k that satisfies N(k)>M (Yes at step S303), the determination unit 103 excludes the work station k from the target to allocate new orders (step S304) since there is no room to allocate new orders. The determination unit 103 then returns to step S301 and repeats the processing for the remaining work stations 11 to be the allocation target.

When there is no work station k that satisfies N(k)>M (No at step S303), the determination unit 103 calculates M−N(k) pieces of orders for each of the work stations k as the number of newly allocated orders J(k) (step S305).

The calculated number of orders J(k) can be used for at least two purposes. The first purpose is to use the largest value of J(k) among those calculated for the work stations k as the target size for clustering.

The second purpose is to use it as reference data when determining which cluster to be allocated to each of the work stations k. For example, the determination unit 103 selects the clusters to be allocated according to the number of orders J(k) at each of the work stations k. As the allocation method, for example, a method utilizing an algorithm for a combinatorial optimization problem called bin packing may be used.

For example, it is assumed that there are two work stations WS1 and WS2 as the work stations 11, and the total number of orders is 15. It is also assumed that four clusters are generated, which are the cluster C1 with two orders, the cluster C2 with three orders, the cluster C3 with four orders, and the cluster C4 with six orders. Furthermore, it is assumed that there are seven remaining orders in process at the work station WS1. In that case, the number of newly allocated orders J (k=WS1) is 4, and the number of orders J (k=WS2) is 11.

The determination unit 103 rearranges the clusters in order from the largest size and allocates the clusters sequentially from the cluster with the largest size to the work station 11 with the smallest number of orders J(k). In the above example, the determination unit 103 determines, in the following order, to allocate the cluster C4 for the work station WS2, the cluster 3 for the work station WS2, the cluster 2 for the work station WS1, and the cluster C1 for the work WS1 (or WS2).

When there are remaining orders in process, it is more likely to increase the simultaneous picking ratio when clusters with a similarity (racks to be used are similar) with respect to the orders in process at the work station 11 are allocated to that work station 11. Therefore, the determination unit 103 may allocate one or more clusters (first clusters) included in a plurality of clusters to the work station 11 that is processing the in-process order data that has a higher similarity with the pieces of order data included in the clusters than the similarity of the in-process order data in the other work stations 11.

Furthermore, when determining the processing sequence of the clusters within each of the work stations 11, it is more likely that orders in process and additional orders are processed in parallel and the simultaneous picking ratio between each of the orders is increased by determining the sequence order such that the cluster that is more similar to the orders in process is processed earlier. Thus, when allocating the clusters (first clusters) to a single work station, the determination unit 103 may determine the cluster with a higher similarity with the in-process order data among the clusters to be earlier in the processing sequence.

While the similarity may be calculated by any method, for example, the same method as that of calculation of the distance between the indexes can be applied. For example, the determination unit 103 considers a group of orders in process as a cluster, applies an index to the cluster using the same method as described above, and calculates the similarity with respect to the cluster by the distance between the indexes.

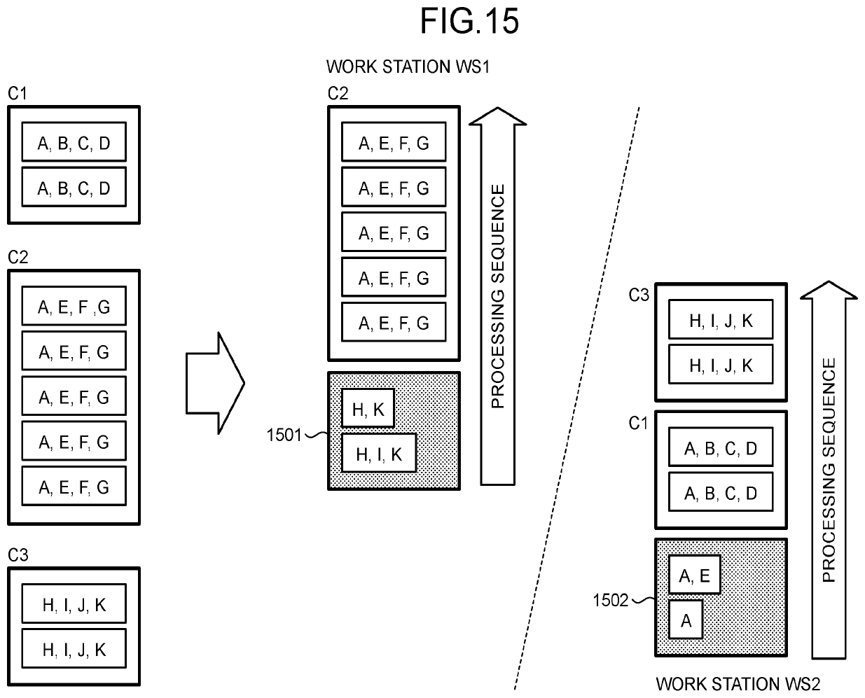

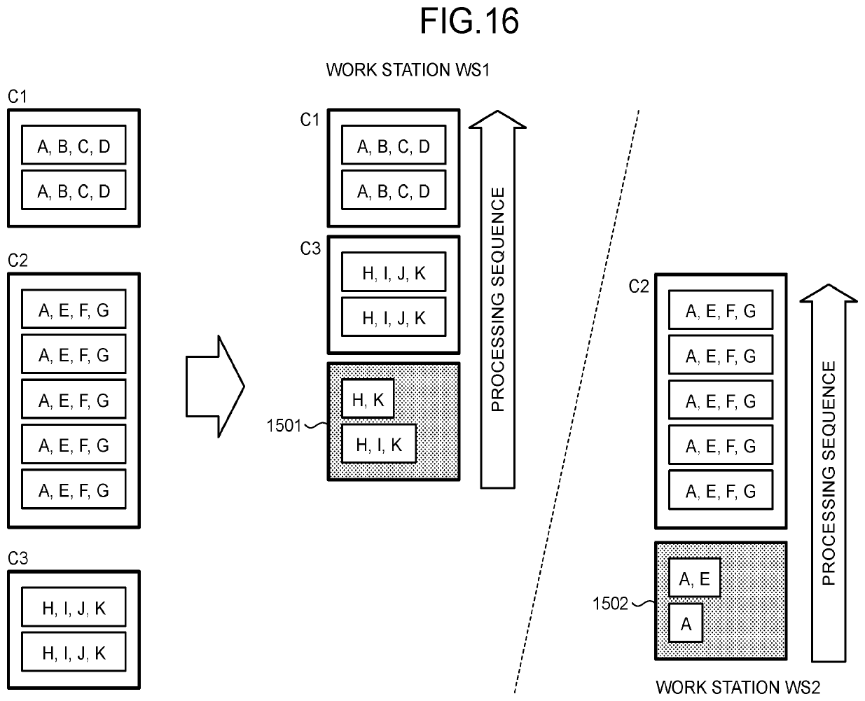

This will be described by referring to the examples illustrated in FIG. 15 and FIG. 16. It is assumed that three clusters C1, C2, and C3 are generated by clustering, and that there are two work stations WS1 and WS2 as the work stations 11, and order groups 1501 and 1502 are orders in process at the work stations WS1 and WS2, respectively. Note that letters A through K represent order IDs in FIG. 15 and FIG. 16.

FIG. 15 is a diagram illustrating an example of determining the processing sequence of clusters when not considering the similarity with respect to the orders in process. In FIG. 15, for example, the cluster C2 in the largest size is allocated to the work station WS1, while the other clusters are allocated to the work station WS2. Furthermore, the processing sequence of the clusters at the work station WS2 is the cluster C1 and then the cluster C3. At the work station WS1, the in-process orders (H, I, K) included in the order group 1501 do not match the orders (A, E, F, G) included in the newly allocated cluster. Thus, the simultaneous picking ratio cannot be improved.

FIG. 16 is a diagram illustrating an example of determining the processing sequence of clusters when considering the similarity with respect to the orders in process. In FIG. 16, the cluster C2 in the largest size is allocated to the work station WS2 with a higher similarity, while the other clusters C1 and C3 are allocated to the work station WS1. Furthermore, the cluster C3 has a higher similarity with respect to the order group 1501 in process than the cluster C1, and therefore, is determined to be earlier in the processing sequence.

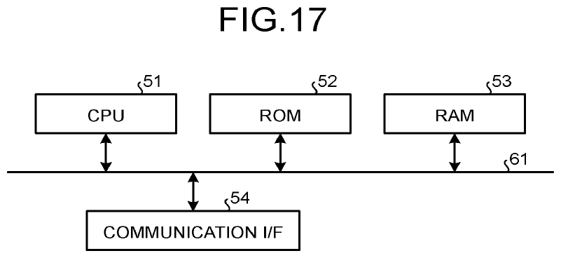

Next, the hardware configuration of the information processing device according to the present embodiment will be described by referring to FIG. 17. FIG. 17 is a diagram illustrating an example of the hardware configuration of the information processing device according to the present embodiment.

The information processing device according to the present embodiment includes a control device such as a CPU 51, memory devices such as a Read Only Memory (ROM) 52 and a RAM 53, a communication I/F 54 that is connected to a network for performing communication, and a bus 61 that connects each of the units.

The computer program to be executed by the information processing device according to the present embodiment is provided by being loaded in advance in the ROM 52 or the like.

The computer program to be executed by the information processing device according to the present embodiment may be recorded in an installable or executable format file on a computer readable recording medium such as a Compact Disc Read Only Memory (CD-ROM), a flexible disk (FD), a Compact Disc Recordable (CD-R), or a Digital Versatile Disc (DVD), and may be provided as a computer program product.

Furthermore, the computer program to be executed by the information processing device according to the present embodiment may be stored on a computer connected to a network such as the Internet and may be provided by being downloaded via the network. The computer program executed by the information processing device according to the present embodiment may be provided or distributed via a network such as the Internet.

The computer program executed by the information processing device according to the present embodiment may cause the computer to function as each of the units of the information processing device described above. As for the computer, the CPU 51 can read the computer program from a computer-readable storage medium and execute it on the main memory.

Configuration examples of the embodiment are described below:

### Configuration Example 1

An information processing device including
a processing unit configured to:
determine, based on a plurality of pieces of rack data including first identification information of one or more kinds of products housed in each of a plurality of racks, a processing sequence of a plurality of pieces of first order data including second identification information of one or more kinds of products to be picked from at least some of the plurality of racks, and one or more racks from which the products identified by the second identification information are to be picked, for each of the plurality of pieces of first order data; and
perform hierarchical clustering that repeats processing of merging a plurality of similar or matching pieces of first order data into a cluster such that a cluster number that is a number of a plurality of clusters resulting from the hierarchical clustering becomes equal to or more than a station number that is a number of a plurality of work stations where housing containers corresponding to at least some pieces of first order data among the plurality of pieces of first order data are placed.

### Configuration Example 2

The information processing device according to Configuration Example 1, wherein the processing unit is configured to allocate the plurality of clusters, in order from a cluster with a largest size, to a work station in which a total size of one or more already-allocated clusters is smaller than another work station.

### Configuration Example 3

The information processing device according to Configuration Example 1 or 2, wherein the processing unit is configured to determine a plurality of pieces of first order data to be allocated to each of the plurality of work stations such that a total of a number of pieces of second order data in process and a number of pieces of first order data to be allocated among the plurality of pieces of first order data is equalized among the plurality of work stations.

### Configuration Example 4

The information processing device according to Configuration Example 3, wherein the processing unit is configured to allocate one or more first clusters included in the plurality of clusters to a work station that is processing the second order data that has a higher similarity with a plurality of pieces of first order data included in the one or more first clusters than another work station.

### Configuration Example 5

The information processing device according to Configuration Example 4, wherein the processing unit is configured to, when allocating a plurality of first clusters to one of the plurality of work stations, determine a first cluster with a higher similarity with the second order data among the plurality of first clusters to be earlier in the processing sequence.

### Configuration Example 6

The information processing device according to any one of Configuration Examples 1 to 5, wherein the processing unit is configured to:
for each of the plurality of racks, calculate a higher priority as a number of pieces of first identification information that matches the second identification information included in the plurality of pieces of first order data is greater; and
for the first order data including the second identification information that matches the first identification information included in the racks selected in order from a highest priority, determine the selected racks as the one or more racks from which the products identified by the second identification information are to be picked.

### Configuration Example 7

The information processing device according to any one of Configuration Examples 1 to 6, wherein the processing unit is further configured to output information indicating at least one selected from: a number of times picking work is performed for each of the plurality of racks, the number of times being calculated based on a ratio of picking products assigned to the first order data from a single rack; and time for the picking work.

### Configuration Example 8

The information processing device according to any one of Configuration Examples 1 to 7, wherein the processing unit is configured to: generate, for the plurality of pieces of first order data, indexes each indicating one or more racks from which the products of the first identification information that matches the second identification information are to be picked among racks housing the products, based on a priority calculated for each of the plurality of racks; and determine the processing sequence using the generated indexes.

### Configuration Example 9

The information processing device according to Configuration Example 8, wherein the processing unit is configured to:
calculate distances between the indexes generated for the plurality of pieces of first order data; and
determine the processing sequence such that turns become closer as a calculated distance is smaller.

### Configuration Example 10

The information processing device according to Configuration Example 9, wherein the processing unit is configured to determine the processing sequence by recursively performing expansion such that child clusters having a common parent cluster are adjacent to each other.

### Configuration Example 11

The information processing device according to any one of Configuration Examples 1 to 10, wherein the processing unit is configured to output output information that indicates the processing sequence and the one or more racks determined for each of the plurality of pieces of first order data.

### Configuration Example 12

The information processing device according to any one of Configuration Examples 1 to 11, wherein the plurality of racks are movable to the plurality of work stations.

### Configuration Example 13

The information processing device according to any one of Configuration Examples 1 to 12, wherein the processing unit is configured to determine, based on the plurality of pieces of rack data, the processing sequence and the one or more racks from which the products identified by the second identification information are picked for each of the plurality of pieces of first order data such that a ratio of picking products assigned to the plurality of pieces of first order data from a single rack is improved.

### Configuration Example 14

The information processing device according to Configuration Example 1, wherein the processing unit includes a determination unit configured to:
determine the processing sequence, and the one or more racks from which the products identified by the second identification information are to be picked; and
execute the hierarchical clustering.

### Configuration Example 15

An information processing method executed by an information processing device, the information processing method including:
determining, based on a plurality of pieces of rack data including first identification information of one or more kinds of products housed in each of a plurality of racks, a processing sequence of a plurality of pieces of first order data including second identification information of one or more kinds of products to be picked from at least some of the plurality of racks, and one or more of the racks from which the products identified by the second identification information are to be picked, for each of the plurality of pieces of first order data; and
performing hierarchical clustering that repeats processing of merging a plurality of similar or matching pieces of first order data into a cluster such that a cluster number that is a number of a plurality of clusters resulting from the hierarchical clustering becomes equal to or more than a station number that is a number of a plurality of work stations where housing containers corresponding to at least some pieces of first order data among the plurality of pieces of first order data are placed.

### Configuration Example 16

A computer program product including a computer-readable medium including programmed instructions, the instructions causing a computer to execute:
determining, based on a plurality of pieces of rack data including first identification information of one or more kinds of products housed in each of a plurality of racks, a processing sequence of a plurality of pieces of first order data including second identification information of one or more kinds of products to be picked from at least some of the plurality of racks, and one or more of the racks from which the products identified by the second identification information are to be picked, for each of the plurality of pieces of first order data; and
performing hierarchical clustering that repeats processing of merging a plurality of similar or matching pieces of first order data into a cluster such that a cluster number that is a number of a plurality of clusters resulting from the hierarchical clustering becomes equal to or more than a station number that is a number of a plurality of work stations where housing containers corresponding to at least some pieces of first order data among the plurality of pieces of first order data are placed.

### Configuration Example 17

An information processing system comprising:
a transfer device;
an information processing device; and
a plurality of work stations, wherein
the transfer device transfers a plurality of racks housing products to the plurality of work stations, and
the information processing device includes a processing unit configured to:
determine, based on a plurality of pieces of rack data including first identification information of one or more kinds of products housed in each of the plurality of racks, a processing sequence of a plurality of pieces of first order data including second identification information of one or more kinds of products to be picked from at least some of the plurality of racks, and one or more racks from which the products identified by the second identification information are to be picked, for each of the plurality of pieces of first order data; and
perform hierarchical clustering that repeats processing of merging a plurality of similar or matching pieces of first order data into a cluster such that a cluster number that is a number of a plurality of clusters resulting from the hierarchical clustering becomes equal to or more than a station number that is a number of the plurality of work stations where housing containers corresponding to at least some pieces of first order data among the plurality of pieces of first order data are placed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
one or more processors configured to:
determine, based on a plurality of pieces of rack data including first identification information of one or more kinds of products housed in each of a plurality of racks, a processing sequence of a plurality of pieces of first order data including second identification information of one or more kinds of products to be picked from at least some of the plurality of racks, and one or more racks from which the products identified by the second identification information are to be picked, for each of the plurality of pieces of first order data; and
perform hierarchical clustering that repeats processing of merging a plurality of similar or matching pieces of first order data into a cluster such that a cluster number that is a number of a plurality of clusters resulting from the hierarchical clustering becomes equal to or more than a station number that is a number of a plurality of work stations where housing containers corresponding to at least some pieces of first order data among the plurality of pieces of first order data are placed.

2. The device according to claim 1, wherein the one or more processors are configured to allocate the plurality of clusters, in order from a cluster with a largest size, to a work station in which a total size of one or more already-allocated clusters is smaller than another work station.

3. The device according to claim 1, wherein the one or more processors are configured to determine a plurality of pieces of first order data to be allocated to each of the plurality of work stations such that a total of a number of pieces of second order data in process and a number of pieces of first order data to be allocated among the plurality of pieces of first order data is equalized among the plurality of work stations.

4. The device according to claim 3, wherein the one or more processors are configured to allocate one or more first clusters included in the plurality of clusters to a work station that is processing the second order data that has a higher similarity with a plurality of pieces of first order data included in the one or more first clusters than another work station.

5. The device according to claim 4, wherein the one or more processors are configured to, when allocating a plurality of first clusters to one of the plurality of work stations, determine a first cluster with a higher similarity with the second order data among the plurality of first clusters to be earlier in the processing sequence.

6. The device according to claim 1, wherein the one or more processors are configured to:
for each of the plurality of racks, calculate a higher priority as a number of pieces of first identification information that matches the second identification information included in the plurality of pieces of first order data is greater; and
for the first order data including the second identification information that matches the first identification information included in the racks selected in order from a highest priority, determine the selected racks as the one or more racks from which the products identified by the second identification information are to be picked.

7. The device according to claim 1, wherein the one or more processors are further configured to output information indicating at least one selected from: a number of times picking work is performed for each of the plurality of racks, the number of times being calculated based on a ratio of picking products assigned to the first order data from a single rack; and time for the picking work.

8. The device according to claim 1, wherein the one or more processors are configured to: generate, for the plurality of pieces of first order data, indexes each indicating one or more racks from which the products of the first identification information that matches the second identification information are to be picked among racks housing the products, based on a priority calculated for each of the plurality of racks; and determine the processing sequence using the generated indexes.

9. The device according to claim 8, wherein the one or more processors are configured to:
calculate distances between the indexes generated for the plurality of pieces of first order data; and
determine the processing sequence such that turns become closer as a calculated distance is smaller.

10. The device according to claim 9, wherein the one or more processors are configured to determine the processing sequence by recursively performing expansion such that child clusters having a common parent cluster are adjacent to each other.

11. The device according to claim 1, wherein the one or more processors are configured to output output information that indicates the processing sequence and the one or more racks determined for each of the plurality of pieces of first order data.

12. The device according to claim 1, wherein the plurality of racks are movable to the plurality of work stations.

13. The device according to claim 1, wherein the one or more processors are configured to determine, based on the plurality of pieces of rack data, the processing sequence and the one or more racks from which the products identified by the second identification information are picked for each of the plurality of pieces of first order data such that a ratio of picking products assigned to the plurality of pieces of first order data from a single rack is improved.

14. The device according to claim 1, wherein the one or more processors include a determination unit configured to:
determine the processing sequence, and the one or more racks from which the products identified by the second identification information are to be picked; and
execute the hierarchical clustering.

15. An information processing method executed by an information processing device, the information processing method comprising:
determining, based on a plurality of pieces of rack data including first identification information of one or more kinds of products housed in each of a plurality of racks, a processing sequence of a plurality of pieces of first order data including second identification information of one or more kinds of products to be picked from at least some of the plurality of racks, and one or more of the racks from which the products identified by the second identification information are to be picked, for each of the plurality of pieces of first order data; and
performing hierarchical clustering that repeats processing of merging a plurality of similar or matching pieces of first order data into a cluster such that a cluster number that is a number of a plurality of clusters resulting from the hierarchical clustering becomes equal to or more than a station number that is a number of a plurality of work stations where housing containers corresponding to at least some pieces of first order data among the plurality of pieces of first order data are placed.

16. A computer program product comprising a computer-readable medium including programmed instructions, the instructions causing a computer to execute:
determining, based on a plurality of pieces of rack data including first identification information of one or more kinds of products housed in each of a plurality of racks, a processing sequence of a plurality of pieces of first order data including second identification information of one or more kinds of products to be picked from at least some of the plurality of racks, and one or more of the racks from which the products identified by the second identification information are to be picked, for each of the plurality of pieces of first order data; and
performing hierarchical clustering that repeats processing of merging a plurality of similar or matching pieces of first order data into a cluster such that a cluster number that is a number of a plurality of clusters resulting from the hierarchical clustering becomes equal to or more than a station number that is a number of a plurality of work stations where housing containers corresponding to at least some pieces of first order data among the plurality of pieces of first order data are placed.

17. An information processing system comprising:
a transfer device;
an information processing device; and
a plurality of work stations, wherein
the transfer device transfers a plurality of racks housing products to the plurality of work stations, and
the information processing device includes a processing unit configured to:
determine, based on a plurality of pieces of rack data including first identification information of one or more kinds of products housed in each of the plurality of racks, a processing sequence of a plurality of pieces of first order data including second identification information of one or more kinds of products to be picked from at least some of the plurality of racks, and one or more racks from which the products identified by the second identification information are to be picked, for each of the plurality of pieces of first order data; and
perform hierarchical clustering that repeats processing of merging a plurality of similar or matching pieces of first order data into a cluster such that a cluster number that is a number of a plurality of clusters resulting from the hierarchical clustering becomes equal to or more than a station number that is a number of the plurality of work stations where housing containers corresponding to at least some pieces of first order data among the plurality of pieces of first order data are placed.
